(19) United States
(12) Patent Application Publication
(10) Pub. No.: US 2021/0129171 A1
(43) Pub. Date: May 6, 2021

(54) FILTER MONITORING SYSTEMS AND METHODS

(71) Applicant: John Baker Sales LLC, Englewood, CO (US)

(72) Inventor: John Baker, Englewood, CO (US)

(21) Appl. No.: 17/088,031

(22) Filed: Nov. 3, 2020

Related U.S. Application Data
(60) Provisional application No. 62/930,818, filed on Nov. 5, 2019.

(51) Int. Cl. B05B 16/60; B01D 46/42; B01D 46/00

(52) U.S. Cl. CPC B05B 16/60; B01D 46/0086; B01D 46/429

(57) ABSTRACT

A system includes a paint booth including a room, a ceiling, and a floor. The system also includes a ceiling filter communicatively coupled to a first opening and a base filter communicatively coupled to a second opening. A first pressure sensor is configured to output a first measurement signal indicative of a first pressure drop across the ceiling filter. A second pressure sensor is configured to output a second measurement signal indicative of a second pressure drop across the base filter. A controller is configured to receive the first measurement signal and the second measurement signal and generate a first alert when the first pressure drop across the ceiling filter is greater than a first threshold pressure drop and generate a second alert when the second pressure drop across the base filter is greater than a second threshold pressure drop.

### CROSS-REFERENCE TO RELATED APPLICATION

This application claims priority to Provisional Application No. 62/930,818, filed Nov. 5, 2019, which is herein incorporated by reference in its entirety.

### SUMMARY

In certain embodiments, a system includes a paint booth with a room, a ceiling, and a floor. The system also includes a ceiling filter communicatively coupled to a first opening and a base filter communicatively coupled to a second opening. The system includes a first pressure sensor that is configured to output a first measurement signal and that is communicatively coupled (1) between an air inlet to the paint booth and the ceiling filter and (2) to the room. The first measurement signal is indicative of a first pressure drop across the ceiling filter. The system also includes a second pressure sensor that is configured to output a second measurement signal and that is communicatively coupled (1) to the room and (2) between the base filter and an air outlet of the paint booth. The second measurement signal is indicative of a second pressure drop across the base filter. The system further includes a controller that is configured to receive the first measurement signal and the second measurement signal and generate a first alert when the first pressure drop across the ceiling filter is greater than a first threshold pressure drop and generate a second alert when the second pressure drop across the base filter is greater than a second threshold pressure drop.

In certain embodiments, a method is disclosed for monitoring filters for a paint booth, air compressor, and the like. The paint booth includes a room, a ceiling with a ceiling filter communicatively coupled to the room, and a floor with a base filter communicatively coupled to the room. The method includes periodically measuring a first pressure drop across the ceiling filter via a first pressure sensor. The first pressure sensor is communicatively coupled to a ceiling chamber and to the room. The method further includes periodically measuring a second pressure drop across the base filter via a second pressure sensor. The second pressure sensor is communicatively coupled to the room and a floor chamber or a duct. The method further includes determining that the first pressure drop is larger than a first pressure drop threshold and generating a responsive first alert signal and determining that the second pressure drop is larger than a second pressure drop threshold and generating a responsive second alert signal.

In certain embodiments, a filter monitoring kit is disclosed as having component parts being capable of being coupled together. The kit includes tubes, wireless transmitters, a first pressure sensor, a second pressure sensor, and a controller. The first pressure sensor is configured to be coupled to a first of the wireless transmitters and to a first pair of the tubes to measure a first pressure drop. The second pressure sensor is configured to be coupled to a second of the wireless transmitters and to a second pair of the tubes to measure a second pressure drop. The controller is programmed to (1) receive a first signal from the first wireless transmitter indicative of the first pressure drop, (2) receive a second signal from the second wireless transmitter indicative of the second pressure drop, (3) generate a first alert when the first pressure drop is greater than a first threshold pressure drop, and (4) generate a second alert when the second pressure drop across the base filter is greater than a second threshold pressure drop.

In certain embodiments, a system includes a first filter communicatively coupled to an air intake, a second filter communicatively coupled to an air exhaust, a first pressure sensor configured to output a first measurement signal and communicatively coupled to a high-pressure side of the first filter and a low-pressure side of the first filter, and a second pressure sensor configured to output a second measurement signal and communicatively coupled to a high-pressure side of the second filter and a low-pressure side of the second filter. The first measurement signal is indicative of a first pressure drop across the first filter, and the second measurement signal is indicative of a second pressure drop across the second filter. A controller is configured to receive the first measurement signal and the second measurement signal and generate a first alert when the first pressure drop across the first filter is greater than a first threshold pressure drop and generate a second alert when the second pressure drop across the second filter is greater than a second threshold pressure drop.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a system, in accordance with certain embodiments of the present disclosure.

FIG. 2 shows a paint booth of the system of FIG. 1, in accordance with certain embodiments of the present disclosure.

FIG. 3 shows a schematic of a ventilation system of the paint booth of FIG. 2, in accordance with certain embodiments of the present disclosure.

FIG. 4 shows a schematic of a user interface for a user account stored on a server, in accordance with certain embodiments of the present disclosure.

FIG. 5 shows a block diagram of steps of a method, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Paint booths are used to create an interior region in which objects such as automobiles can be painted in a controlled environment. Paint booths can use various systems and components to control the temperature, humidity, and flow rate of air passing through the paint booth. Further, paint booths may use various filters (e.g., air filters) to help keep unwanted particulates from entering the paint booth or exiting the paint booth. With use, these filters become dirty and clogged with debris, etc., such that the filters are less efficient and allow less air to flow through the filters. Typically, used filters are not replaced until the inefficiency of the filters is such that an operator notices an effect on the drying conditions within the paint booth. Alternatively, used filters are changed on an arbitrary schedule that may result in relatively clean and efficient filters being replaced unnecessarily. Certain embodiments of the present disclosure are accordingly directed to filter monitoring systems and methods.

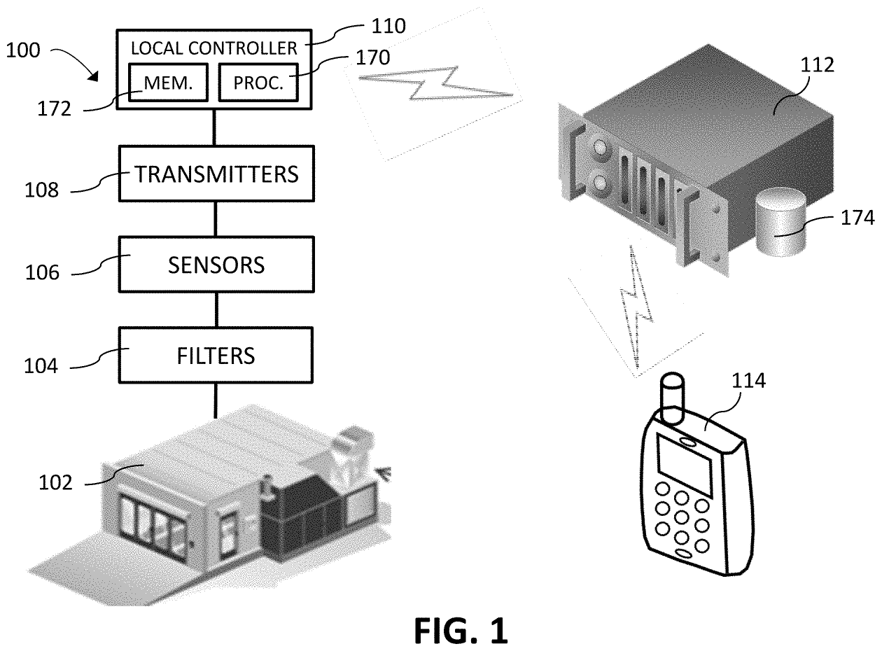

FIG. 1 shows a system 100 including a paint booth 102, filters 104, sensors 106, transmitters 108, a local controller 110, a server 112, and a user device 114. The various electronics can be communicatively coupled to each other via wired or wireless means.

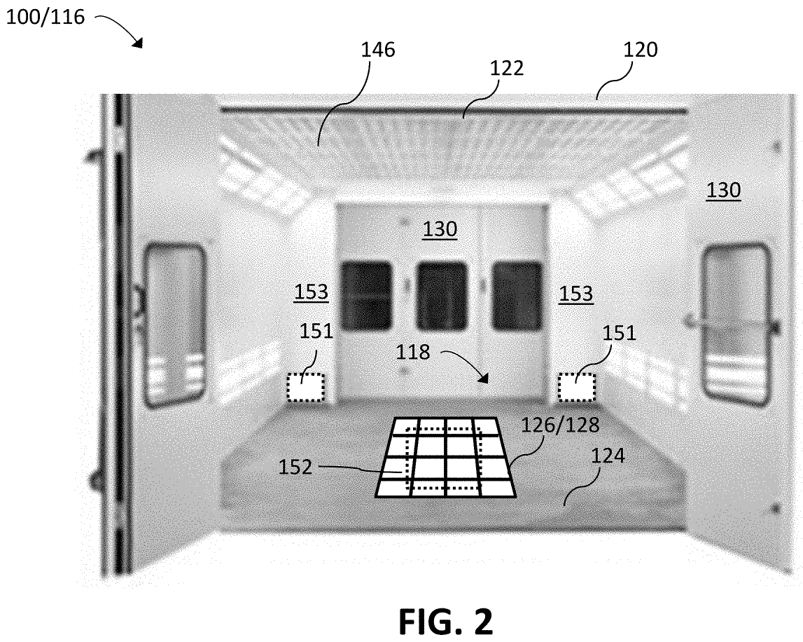

FIG. 2 shows the paint booth 102 with a housing 116 that forms an interior region 118 (e.g., a room). The paint booth 102 includes a ceiling 120 with a ceiling opening 122 and a floor 124 with a floor opening 126, which can be at least partially covered by gratings 128. As will be described in more detail below, in certain embodiments, the paint booth 102 can include a floor without an opening. The paint booth 102 can also include various entry points 130 (e.g., doorways) to allow access to the interior region 118.

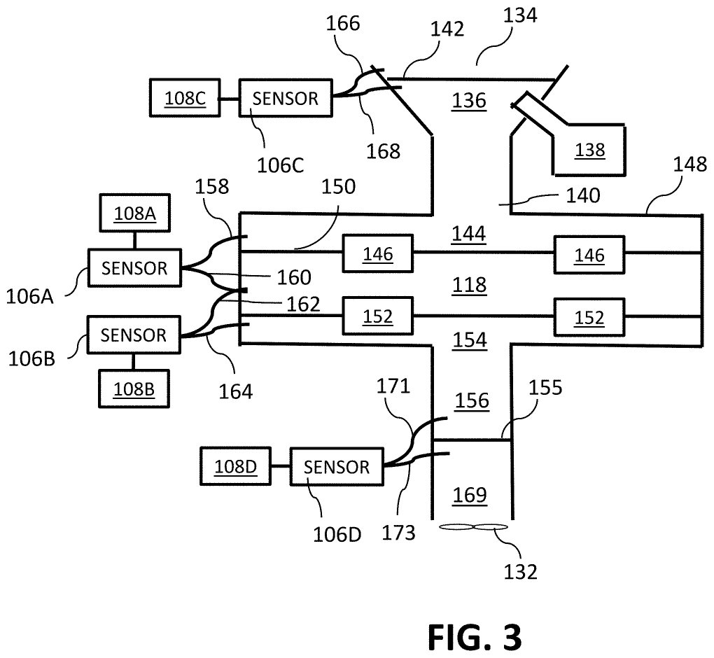

FIG. 3 shows a schematic of a ventilation system of the paint booth 102 with various components, some of which are also shown in FIG. 2. The components are not drawn to scale but are arranged to show how air may flow through the paint booth 102.

During operation of the paint booth 102, air is initially drawn into the paint booth 102 by one or more fans 132 via an air intake 134. The air can be heated (directly with a flame or indirectly) in a heater section 136 by a heater 138 before the air passes through an air inlet 140. In certain embodiments, before passing through the heater section 136 and/or the air inlet 140, the air is filtered by a burner filter 142. The burner filter 142 can be designed to catch larger-sized particles that enter the paint booth 102 from the external environment via the air intake 134.

After passing through the air inlet 140, the air enters a ceiling chamber 144 between the air inlet and a ceiling filter 146 that is at least partially positioned in the ceiling opening 122. In certain embodiments, because the air inlet 140 is smaller in size than the ceiling opening 122, the ceiling chamber 144 can include sidewalls 148 that guide the air from the air inlet 140 towards the ceiling filter 146. The air then passes through the ceiling filter 146 and into the interior region 118. In certain embodiments, a rack 150 is positioned within the ceiling opening 122 and designed to hold multiple ceiling filters 146.

The interior region 118 is where users position and paint objects. For example, the user may position an automobile, parts of an automobile, or other objects on or above the floor 124 or gratings 128 in the floor 124. As the object is painted, excess paint is carried by the air flowing through the interior region 118 towards the opening 126 in the floor 124. As such, the ventilation system of the paint booth 102 creates a downward draft of air in the interior region 118 between the ceiling 120 and the floor 124. In embodiments without the opening 126 in the floor 124, the interior region 118 can be communicatively coupled to openings 151 (shown in FIG. 2) near the floor 124 on the side on the paint booth 102. As such, no opening or floor chamber is needed to exhaust the air from the paint booth 102. Additionally or alternatively, the air can be passed from one side of the paint booth 102 to the other side of the paint booth 102 to generate a cross draft within the paint booth 102. In such embodiments, the paint booth 102 can have various openings to enable the cross draft.

Air and paint overspray, etc., is directed towards the opening 126 in the floor 124 (or the openings 151 on the side of the paint booth 102) and is filtered by one or more paint filters 152 (shown in FIG. 2 in dotted lines and hereinafter referred to as the base filters 152). For example, overspray and solvents carried by the air can be collected by the base filters 152. In embodiments with only the openings 151, the paint booth 102 can include base filters 152 that are positioned within ducts 153 on the side of the paint booth 102.

The base filter 152 can be communicatively coupled to the opening 126 in the floor 124 and can be at least partially positioned in the opening 126. In certain embodiments, a rack 154 is positioned in the opening 126 and/or below the floor 124 such that multiple base filters 152 can be used. After passing through the base filter 152, the air enters a floor chamber 154 (shown in FIG. 3) (and/or the ducts 153 shown in FIG. 2) and then can pass towards an exhaust filter 155 and then exit from the ventilation system via an air output 156.

As described above, the system 100 includes various sensors 106, including a first pressure sensor 106A, a second pressure sensor 106B, a third pressure sensor 106C (shown in FIG. 3), and a fourth pressure sensor 106D (shown in FIG. 3). The various sensors 106 can be arranged to help monitor the various filters 104 (e.g., the burner filter 142, the ceiling filter 146, the base filter 152, and/or the exhaust filter 155). In particular, the sensors 106 can be used to measure pressure drops across the filters 104. As the filters 104 become dirtier and more clogged, the pressure drop across a given filter (e.g., the difference in air pressure between both sides of the filter) will increase. When the pressure drop reaches a given threshold (or crosses multiple thresholds), the filter can be identified as being ready for replacement with a clean filter. Although the sensors 106, the controller 110, and other components described herein are discussed in the context of paint booths, the components can be arranged and coupled to monitor filters in other applications (e.g., air compressors, furnaces).

The first pressure sensor 106A is configured to measure a pressure drop across the ceiling filter(s) 146. In certain embodiments, the first pressure sensor 106A is communicatively coupled to the ceiling chamber 144 (e.g., the area between the air inlet 140 and the ceiling filter 146) and the interior region 118. For example, the first pressure sensor 106A can be coupled to a first tube 158 (e.g., a hollow flexible or solid tube able to pass air through) that extends between the first pressure sensor 106A and the ceiling chamber 144 and be coupled to a second tube 160 that extends between the first pressure sensor 106A and the interior region 118. As such, the first pressure sensor 106A can measure the air pressure of the ceiling chamber 144 (e.g., the high-pressure side of the ceiling filter 146) and the air pressure of the interior region 118 (e.g., the low-pressure side of the ceiling filter 146). The first pressure sensor 106A can generate and output a first measurement signal that is indicative of the pressure drop across the ceiling filter 146. When the paint booth 102 includes multiple ceiling filters 146, the first measurement signal can be indicative of the pressure drop across all of the collective ceiling filters 146 in the paint booth 102. Put another way, the first measurement signal can be indicative of the pressure difference between the ceiling chamber 144 and the interior region 118 of the paint booth 102.

In certain embodiments, the first tube 158 is attached to an opening in the paint booth 102 that is positioned away from the air inlet 140. The air pressure in the air inlet 140 and near where the air exits the air inlet 140 is greater than the rest of the ceiling chamber 144. If the first tube 158 was positioned in or near the air inlet 140, the measured pressure is more likely to not be indicative of the overall air pressure of the ceiling chamber 144.

The second pressure sensor 1068 is configured to measure a pressure drop across the base filter(s) 152. In certain embodiments, the second pressure sensor 106B is communicatively coupled to the interior region 118 and the floor chamber 154 (e.g., the area between the base filter 152 and the air outlet 156). For example, the second pressure sensor 1068 can be coupled to a third tube 162 that extends between the second pressure sensor 106B and the interior region 118 and be coupled to a fourth tube 164 that extends between the second pressure sensor 106B and the floor chamber 154. In certain embodiments, the second tube 160 and the third tube 162 are communicatively coupled to a shared tube portion such that only one tap is required to detect the air pressure of the interior region 118. The second pressure sensor 1068 can measure the air pressure of the interior region 118 (e.g., the high-pressure side of the base filter 152) and the air pressure of the floor chamber 154 (e.g., the low-pressure side of the base filter 152). The second pressure sensor 1068 can generate and output a second measurement signal that is indicative of the pressure drop across the base filter 152. When the paint booth 102 includes multiple base filters 152, the second measurement signal can be indicative of the pressure drop across all of the collective base filters 152 in the paint booth 102.

In certain embodiments, the fourth tube 164 is attached to an opening in the paint booth 102 that is positioned away from the air outlet 156. The air pressure in the air outlet 156 and near where the air enters the air outlet 156 is greater than the rest of the floor chamber 154. If the fourth tube 164 was positioned in or near the air outlet 156, the measured pressure is more likely to not be indicative of the overall air pressure of the floor chamber 154.

The third pressure sensor 106C is configured to measure a pressure drop across the burner filter 142. In certain embodiments, the third pressure sensor 106C is communicatively coupled between the input to the ventilation system and the burner filter 142 as well as to the ceiling chamber 144 (e.g., the area between the air inlet 140 and the ceiling filter 146). For example, the third pressure sensor 106C can be coupled to a fifth tube 166 that extends between the third pressure sensor 106C and the area between the input to the ventilation system and the burner filter 142. The third pressure sensor 106C can also be coupled to a sixth tube 168 that extends between the third pressure sensor 106C and the ceiling chamber 144. As such, the third pressure sensor 106C can measure the air pressure of the ceiling chamber 144 (e.g., the low-pressure side of the burner filter 142) and the air pressure of the area between the input to the ventilation system and the burner filter 142 (e.g., the high-pressure side of the burner filter 142). The third pressure sensor 106C can generate and output a third measurement signal that is indicative of the pressure drop across the burner filter 142. When the paint booth 102 includes multiple burner filters 142, the third measurement signal can be indicative of the pressure drop across all of the collective burner filters 142 in the paint booth 102.

The fourth pressure sensor 106D is configured to measure a pressure drop across the exhaust filter 155. In certain embodiments, the fourth pressure sensor 106D is communicatively coupled to the air outlet 156 and an air exhaust 169. For example, the fourth pressure sensor 106D can be coupled to a seventh tube 171 that extends between the fourth pressure sensor 106D and the air outlet 156. The fourth pressure sensor 106D can also be coupled to an eighth tube 173 that extends between the fourth pressure sensor 106D and the air exhaust 169. As such, fourth pressure sensor 106D can measure the air pressure of the air outlet 156 (e.g., the high-pressure side of the exhaust filter 155) and the air pressure of the air exhaust 169 (e.g., the low-pressure side of the exhaust filter 155). The fourth pressure sensor 106D can generate and output a fourth measurement signal that is indicative of the pressure drop across the exhaust filter 155.

Although four pressure sensors 106A-D are shown in FIG. 3, the paint booth 102 can utilize fewer or additional pressure sensors depending on the number of desired filters or filter locations to monitor. In certain embodiments, the pressure sensors 106A-D can be positioned within various areas of the paint booth 102 instead of being positioned externally and coupled to the various areas via tubes. For example, separate pressure sensors could be respectively positioned in each area (or otherwise communicatively coupled to each area) and be configured to measure pressure (e.g., absolute pressure) of the given area. The measured pressures could be used to calculate respective pressure drops across the various filters.

The first pressure sensor 106A, the second pressure sensor 106B, the third pressure sensor 106C, and the fourth pressure sensor 106D are communicatively coupled to one or more transmitters 108. For example, as shown in FIG. 3, the first pressure sensor 106A can be communicatively coupled to a first transmitter 108A, the second pressure sensor 1068 can be communicatively coupled to a second transmitter 108B, the third pressure sensor 106C can be communicatively coupled to a third transmitter 108C, and the fourth pressure sensor 106D can be communicatively coupled to a fourth transmitter 108D.

The transmitters 108 can be wireless transmitters such as machine-to-machine transmitters that communicate with the local controller 110 (shown in FIG. 2 and hereafter referred to as the controller 110) using a wireless protocol. In other embodiments, the pressure sensors 106 are hardwired to the controller 110. In certain embodiments, the sensors 106 and the transmitters 108 are positioned outside the interior region 118 or outside the paint booth 102. The controller 110 can be part of a local control panel, which is mounted on or near the paint booth 102 and includes various input (e.g., keyboard, switches, buttons) for controlling other aspects of the paint booth 102 such as flow rate, air temperature, humidity, and the like.

The controller 110 can include at least one processor 170 (shown in FIG. 1) (e.g., a microprocessor) that executes software code and/or firmware code stored in memory 172 (shown in FIG. 1) of the controller 110. The software/firmware code contains instructions that, when executed by the processor 170, cause the controller 110 to perform various functions described herein. The controller 110 may include one or more application-specific integrated circuits (ASICs), field-programmable gate arrays (FPGAs), digital signal processors (DSPs), hardwired logic, or combinations thereof.

The controller 110 is configured to receive the various measurement signals from the pressure sensors 106A-D described above. In certain embodiments, the controller 110 is programmed to generate various alerts (e.g., alert signals) in response to certain conditions of the filters 104. For example, the controller 110 can generate an alert when the pressure drop across any one of the filters 104 (e.g., the burner filter 142, the ceiling filter 148, the base filter 152, and the exhaust filter 155) is greater than a set threshold.

As a more specific example, the controller 110 can receive the measurement signal from the first pressure sensor 106A (indicating the magnitude of a pressure drop across the ceiling filter 148) and compare that measurement signal to a threshold pressure drop. If the measurement signal indicates a pressure drop that is larger than the threshold pressure drop, the controller 110 can generate an alarm. In response to the threshold breach, a signal can be transmitted to the server 112 that indicates the breach and includes information the specific filter (e.g., the ceiling filter 148 in the present example) associated with the breach. In other embodiments, the controller 110 can first calculate the pressure drop across the ceiling filter 148 and compare the calculated pressure drop to the threshold pressure drop.

Additionally or alternatively, in response to the threshold breach, a message indicating the breach and the specific filter associated with the breach can be e-mailed, texted, etc., to a designated user. In certain embodiments, the controller 110 can use different thresholds for to generate different alarms. For example, a breach of a first, low pressure drop threshold could cause an initial alarm, which triggers a notification (e.g., e-mail, text) reminding the recipient to order new filters or to check their inventory of filters. Additionally or alternatively, the initial alarm could trigger a purchase of such filters.

A breach of a second, medium pressure drop threshold could cause a second alarm, which triggers a notification that the respective filter(s) should be replaced. Additional alarms and pressure drop thresholds could be used as well. Further, if the controller 110 determines that the pressure drop threshold remains breached (e.g., indicating that the respective filter(s) have not been replaced), the controller 110 can repeat the notifications or send additional notifications to other users. For example, if the filter(s) causing the threshold breach have not been replaced after a certain period of time (e.g., one day) and the pressure drop across such filters remains above the pressure drop threshold, a notification can be sent to a second recipient (e.g., a manager). In certain embodiments, the controller 110 is programmed to send only one notification per day per filter or per set of filters (e.g., one notification for all ceiling filters) in a given paint booth to mitigate the notifications being a nuisance to users. In certain embodiments, the comparison between the measurement signals and the various thresholds occurs every 10-90 seconds.

As another more specific example, the controller 110 can be programmed to receive the measurement signal from the second pressure sensor 106B (indicating the magnitude of a pressure drop across the base filter 152) and compare that measurement signal to a threshold pressure drop. If the measurement signal indicates a pressure drop that is larger than the threshold pressure drop, the controller 110 can generate an alarm. In response to the threshold breach, a signal can be transmitted to the server 112 that indicates the breach and includes information the specific filter (e.g., the ceiling filter 152 in the present example) associated with the breach. Additionally or alternatively, in response to the threshold breach, a message indicating the breach and the specific filter associated with the breach can be e-mailed, texted, etc., to a designated user. A similar process can be followed with the burner filter 142 and the exhaust filter 155.

Although many of the various functions discussed above are described as being carried out by the controller 110, some or all of these functions could be carried out by the server 112 or another computing device that is remote from the paint booth 102. For example, the various measurement signals could be transmitted directly to the server 112, which could determine whether certain pressure drop thresholds have been breached, etc.

The server 112 can include data storage devices 174 and be configured to communicate with the controller 110. The server 112 can store information relating to a plurality of user accounts, which may each be associated with at least one paint booth 102 with filters 104. For example, the server 112 can store information that it has received an alert signal for a particular filter associated with a user account. This type of information can be stored by the server 112 for hundreds or thousands of individual user accounts.

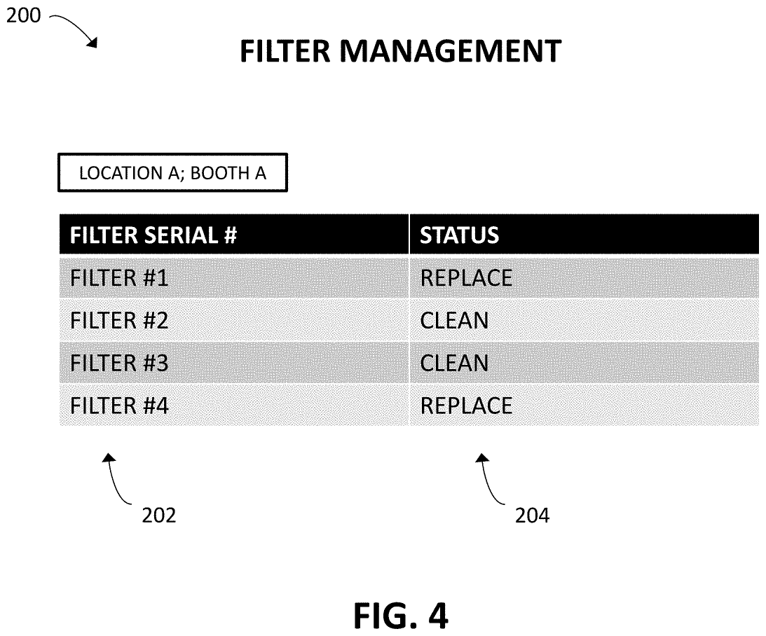

FIG. 4 shows an example user interface 200 that can be accessed by a user and displayed by the user device 114. The user interface 200 shown in FIG. 4 is associated with one paint booth at one location, although additional paint booths and locations can be accessed via a single user account. The paint booth being monitored via the user interface 200 has four filters. Each filter is associated with a unique identifier (e.g., a serial number) as shown in the filter column 202 of the user interface 200. The unique identifier may be that of the transmitter associated with a given filter or the filter location within the paint booth. For example, the first-listed unique identifier may be that assigned to the transmitter coupled to a pressure sensor measuring a pressure drop across a ceiling filter or set of ceiling filters. A status column 204 in the user interface 200 can indicate whether a given filter needs to be replaced (e.g., is associated with a breached threshold) or is clean. The user interface could include other information such as the date and time of when the status last changed.

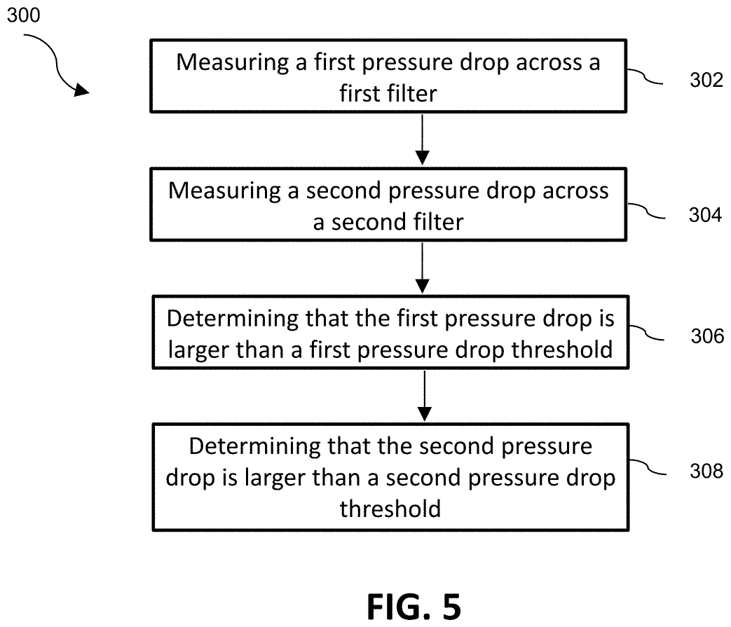

FIG. 5 shows a block diagram of steps of a method 300 for monitoring filters of devices, structures, and systems. The method 300 includes periodically measuring a first pressure drop across a first filter via the first pressure sensor (block 302 in FIG. 5). The method 300 further includes periodically measuring a second pressure drop across a second filter via the second pressure sensor (block 304 in FIG. 5). The method 300 further includes determining that the first pressure drop is larger than a first pressure drop threshold and generating a responsive first alert signal (block 306 in FIG. 5). The method 300 also includes determining that the second pressure drop is larger than a second pressure drop threshold and generating a responsive second alert signal (block 308 in FIG. 5).

In some embodiments, various components of the system 100 described above can be sold as a kit. For example, the sensors 106, the associated tubing for coupling to areas of the paint booth 102, the transmitters 108, and the programmed controller 110 can be sold as separate components in a kit where the various components are sold without being coupled to each other. As described above, when the kit components are coupled to each other, parts of the paint booth 102, and the server 112, the coupled components can provide a system to monitor filters of the paint booth 102. When provided as a kit, the various components can be retrofitted to an already installed and assembled paint booth. The kit can also include various wiring harnesses and mounting structures to assist with mechanically coupling the components of the kit to the paint booth 102.

Although the various components described above have been discussed in the context of filters in a paint booth, the components can be arranged and coupled to monitor filters in other applications. For example, the components of the kit described immediately above can be arranged and coupled together to an air compressor, which may use one or more filters that need to be replaced periodically. In other embodiments, the components of the kit can be arranged and coupled together to furnace or other HVAC system with filters.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

What is claimed is:

1. A system comprising:
a paint booth including a room, a ceiling, and a floor;
a ceiling filter communicatively coupled to a first opening;
a base filter communicatively coupled to a second opening;
a first pressure sensor configured to output a first measurement signal and communicatively coupled (1) between an air inlet to the paint booth and the ceiling filter and (2) to the room, wherein the first measurement signal is indicative of a first pressure drop across the ceiling filter;
a second pressure sensor configured to output a second measurement signal and communicatively coupled (1) to the room and (2) between the base filter and an air outlet of the paint booth, wherein the second measurement signal is indicative of a second pressure drop across the base filter; and
a controller configured to receive the first measurement signal and the second measurement signal and generate a first alert when the first pressure drop across the ceiling filter is greater than a first threshold pressure drop and generate a second alert when the second pressure drop across the base filter is greater than a second threshold pressure drop.

2. The system of claim 1, further comprising:
a first wireless transmitter coupled to the first pressure sensor and configured to transmit the first measurement signal to the controller; and
a second wireless transmitter coupled to the second pressure sensor and configured to transmit the second measurement signal to the controller.

3. The system of claim 1, wherein the controller is configured to send the first alert and the second alert to a server.

4. The system of claim 3, wherein the server stores information relating to a plurality of accounts each associated with at least one separate paint booth, with each separate paint booth associated with a plurality of filters.

5. The system of claim 4, wherein the server is configured to generate a display showing a current status of each of the plurality of filters for one of the plurality of accounts.

6. The system of claim 5, wherein the current status is displayed as a replace status for filters associated with either the first alert or the second alert sent to the server.

7. The system of claim 1, wherein the ceiling filter is at least partially positioned in the first opening.

8. The system of claim 1, wherein the base filter is at least partially positioned in the second opening.

9. The system of claim 1, wherein the base filter is at least partially positioned in a duct of the paint booth.

10. The system of claim 1, wherein the second opening is an opening in the floor.

11. The system of claim 1, wherein the second opening is an opening on a sidewall of the paint booth.

12. The system of claim 1, wherein the controller is configured to generate a third alert when the first pressure drop across the ceiling filter is greater than a third threshold pressure drop and generate a fourth alert when the second pressure drop across the base filter is greater than a fourth threshold pressure drop.

13. The system of claim 1, wherein the first pressure sensor and the second pressure sensor are communicatively coupled to the room at least partially via a shared tube.

14. The system of claim 1, wherein the first pressure sensor and the second pressure sensor are positioned outside the room.

15. The system of claim 1, wherein first pressure sensor positioned away from the air inlet.

16. A method for monitoring a paint booth with a room, a ceiling with a ceiling filter communicatively coupled to the room, and a floor with a base filter communicatively coupled to the room, the method comprising:
periodically measuring a first pressure drop across the ceiling filter via a first pressure sensor, the first pressure sensor communicatively coupled to a ceiling chamber and to the room;
periodically measuring a second pressure drop across the base filter via a second pressure sensor, the second pressure sensor communicatively coupled to the room and a floor chamber or a duct;
determining that the first pressure drop is larger than a first pressure drop threshold and generating a responsive first alert signal; and
determining that the second pressure drop is larger than a second pressure drop threshold and generating a responsive second alert signal.

17. A filter monitoring kit having component parts being capable of being coupled together, the filter monitoring kit comprising:
tubes;
wireless transmitters;
a first pressure sensor configured to be coupled to a first of the wireless transmitters and to a first pair of the tubes to measure a first pressure drop;
a second pressure sensor configured to be coupled to a second of the wireless transmitters and to a second pair of the tubes to measure a second pressure drop; and
a controller programmed to (1) receive a first signal from the first wireless transmitter indicative of the first pressure drop, (2) receive a second signal from the second wireless transmitter indicative of the second pressure drop, (3) generate a first alert when the first pressure drop is greater than a first threshold pressure drop, and (4) generate a second alert when the second pressure drop across the base filter is greater than a second threshold pressure drop.
